(19) United States
(12) Patent Application Publication
(10) Pub. No.: US 2019/0131043 A1
(43) Pub. Date: May 2, 2019

(54) Electric Coil Winding

(71) Applicant: Siemens Aktiengesellschaft, Muenchen (DE)

(72) Inventors: Anne Bauer, Fürth (DE); Hans-Peter Krämer, Erlangen (DE); Manfred Wohlfart, Wiesenthau (DE)

(73) Assignee: Siemens Aktiengesellschaft, Muenchen (DE)

(21) Appl. No.: 16/094,739

(22) PCT Filed: Apr. 6, 2017
(86) PCT No.: PCT/EP2017/058190

§ 371 Date: Oct. 18, 2018

(30) Foreign Application Priority Data
Apr. 19, 2016 (DE) 10 2016 206 573.4

(51) Int. Cl. H01F 6/06; H01F 6/04

(52) U.S. Cl. CPC H01F 6/06; H01F 6/04

(57) ABSTRACT

Various embodiments may include an electric coil winding comprising: an electric conductor; a non-conductive element wound in parallel to the electric conductor throughout a number of turns forming a coil; and a first retaining element arranged in a first end region of the coil. The non-conductive element may be mechanically secured to the retaining element by means an elastic tensile element.

### CROSS-REFERENCE TO RELATED APPLICATIONS

This application is a U.S. National Stage Application of International Application No. PCT/EP2017/058190 filed Apr. 6, 2017, which designates the United States of America, and claims priority to DE Application No. 10 2016 206 573.4 filed Apr. 19, 2016, the contents of which are hereby incorporated by reference in their entirety.

### TECHNICAL FIELD

The present disclosure relates to electrical machines. Various embodiments may include an electric coil winding comprising an electric conductor, a non-conductive element and at least one first retaining element, wherein the electric conductor and the non-conductive element are wound in parallel with one another in a plurality of turns.

### BACKGROUND

In many known coil windings, electric conductors are wound in an alternating arrangement with non-conductive elements, in a sequence of mutually superimposed windings. The non-conductive elements arranged between the conductor windings thereby insulate the individual conductor windings from one another. The electric conductors can comprise superconducting or normally conducting conductor elements. In the case of the superconducting conductor elements, additionally to the superconducting material, one or a plurality of normally conducting conductor paths can also be provided.

In conventional wet-wound coil windings, an adhesive and/or impregnating agent is applied to the individual windings in conjunction with the winding process and is then cured subsequently to the actual winding process, such that a mechanically and dimensionally stable coil bobbin is constituted. Dry-wound coils, i.e. coils incorporating no such adhesive or impregnating agent, can also be embedded, adhesive-bonded, or impregnated further to the winding process, in order to obtain a dimensionally stable coil bobbin of this type. However, there are also dry-wound coils in which the windings are not mutually connected, or are only partially or only loosely mutually connected. In dry coil windings of this type, there is a risk that, once the coil has been wound, the individual winding layers of the electric conductor and the non-conductive element can become displaced in relation to one another, after the manufacture of the coil. Specifically, as a result of the electrical operation of a coil winding of this type, or as a result of temperature variations associated with the cooling or heat-up thereof to a service temperature which differs from the manufacturing temperature, forces can be generated which displace the individual winding layers in relation to one another.

In order to resolve the issue of the potential displacement of the electric conductor and/or of the non-conductive element from the fully-wound coil winding, the non-conductive element in conventional coil windings is typically mechanically secured to the ends of the coil winding. For example, the non-conductive element can be screwed to the two contact elements which are employed for the electrical contacting of the electric conductor. In many cases, these are copper blocks, which are arranged in radially interior and/or exterior regions of the coil winding and, at the two end regions of the conductor, are electrically connected to the latter. If both the conductor and the non-conductive element are mechanically attached to these contact elements, any mutual displacement of the former two elements can sometimes be prevented, but only for such time as there is no action of additional forces, or any expansion or contraction of said elements.

It is specifically problematic, however, if adjacent conductor branches repel each other during operation, or if the conductor and the non-conductive element, during operation and/or in response to a temperature variation, undergo a different change in length. In such cases, in the event of the conventional attachment of the winding elements, a mutual displacement of the different elements can easily occur. The compact and mechanically stable composite structure of the coil winding can be compromised as a result. In dry-wound flat coils, and flat coils which are not subsequently embedded or adhesive-bonded, a problem then arises, in that the conductor and/or the non-conductive element, in the axial direction, i.e. perpendicularly to the winding plane of the coil, can shift out of the coil plane. Such coils will then not be mechanically stable in service.

### SUMMARY

The teachings of the present disclosure may be embodied in an electric coil winding which overcomes the above-mentioned disadvantages. Specifically, a coil winding which, even in the absence of adhesive-bonding or embedding in a fixing medium, is mechanically stable in service. In service, the composite structure of the winding should thus be maintained, with no shifting of the electric conductor and the non-conductive element in relation to one another, and no loss of the mechanical integrity thereof in the coil winding.

For example, some embodiments may include an electric coil winding (1) comprising an electric conductor (3), a non-conductive element (5) and at least one first retaining element (7a). The electric conductor (3) and the non-conductive element (5) are wound in parallel with one another in a plurality of turns. The first retaining element (7a) is arranged in a first end region (9a) of the coil winding (1). The non-conductive element (5) is mechanically secured to the retaining element (7a) by means of at least one elastic tensile element (11).

In some embodiments, both the electric conductor (3) and the non-conductive element (5) are constituted of a strip material, and the coil winding (1) is configured as a flat coil with mutually superimposed layers of the strip material elements.

In some embodiments, the electric conductor (3) comprises a superconducting conductor material.

In some embodiments, the first end region (9a) is arranged in an outer radial position.

In some embodiments, the retaining element (7a) is configured as an electric contact element, to which the electric conductor (3) is connected in an electrically conductive manner.

In some embodiments, the non-conductive element (5) is configured as a spacer between individual and mutually superimposed turns of the electric conductor (3).

In some embodiments, the non-conductive element (5) incorporates one or more cavities (13), through which a coolant fluid (15) can flow.

In some embodiments, the non-conductive element (5) comprises a corrugated strip (17).

In some embodiments, the non-conductive element (5) is at least partially constituted of a plastic.

In some embodiments, the non-conductive element (5) is configured with a greater width than the electric conductor (3).

In some embodiments, the non-conductive element (5), in an interior region (19) relative to the width thereof, incorporates a recess (21), or a series of recesses (21), in which the electric conductor (3) is carried.

In some embodiments, the non-conductive element (5) is constituted of a plurality of parts (17, 18).

In some embodiments, the elastic tensile element (11) can exert a tensile force of at least 5 N on the non-conductive element (5).

In some embodiments, the electric conductor (3) comprises at least two conductor branches (3a, 3b), and wherein at least two adjacent conductor branches (3a, 3b) in the winding are configured for mutually opposing directions of current flow (Ia, Ib).

As another example, some embodiments may include a fault current limiter having an electric coil winding (1) as described above.

### BRIEF DESCRIPTION OF THE DRAWINGS

The teachings herein are further described hereinafter by way of a number of exemplary embodiments, with reference to the attached drawings, in which:

FIG. 1 shows a schematic view of a bifilar flat coil winding of a fault current limiter incorporating teachings of the present disclosure;

FIG. 2 shows a non-conductive element of the coil winding, configured as a spacer with an electric conductor arranged therein, in a schematic oblique view, incorporating teachings of the present disclosure;

FIG. 3 shows the first end region 9a from FIG. 1, in a schematic side view for a configuration according to the prior art; and

FIG. 4 shows the first end region 9a from FIG. 1, in a schematic side view incorporating teachings of the present disclosure.

### DETAILED DESCRIPTION

Various embodiments of the teachings herein include a coil winding comprising at least one electric conductor, at least one non-conductive element, and at least one first retaining element. The electric conductor and the non-conductive element are wound in parallel with one another in a plurality of turns, wherein the first retaining element is arranged in a first end region of the coil winding, and wherein the non-conductive element is mechanically secured to the retaining element by means of at least one elastic tensile element.

The elastic tensile element can be, for example, a tension spring, but can also be another elastic element, by means of which the non-conductive element is secured to the retaining element, by the action of a tensile force. For example, this can be a rubber band, or an element of a similarly elastic material, such as rubber. By the configuration of the elastic attachment of the non-conductive element to the retaining element, the non-conductive element can be maintained under tension, separately from the electric conductor. Specifically, the coil winding is thus configured such that the electric conductor is mechanically dissociated from the tensile force exerted by the elastic tensile element.

For example, the electric conductor can be rigidly mechanically attached to the retaining element, or to any other element. By this arrangement, the non-conductive element is maintained under mechanical tension, separately from the electric conductor. During the operation of the coil winding and/or in the event of the cooling or heat-up thereof to a service temperature, the forces occurring can be cushioned, and any differential variations in length between the electric conductor and the non-conductive element can be offset. Accordingly, notwithstanding the action of a force, there is then no unwanted displacement of the electric conductor and/or of the non-conductive element from the local winding plane.

In some embodiments, even a dry coil remains mechanically stable, as the non-conductive element which is retained by a tensile force also secures the electric conductor which is guided parallel thereto within the individual turns of the winding. In the end regions of the coil winding, there is likewise no shifting of the conductive and non-conductive elements out of the winding plane, as any variations in length can be compensated by the elastic tensile element, and do not need to be compensated by any displacement out of the winding plane. This also applies specifically to the outermost turns of the winding, i.e. for example the radially innermost and the radially outermost windings of a flat coil. In the event of the rigid attachment of the electric conductor and the non-conductive element, shifting of the winding elements associated with variations in the length thereof or electrical repulsion between the conductor windings can very easily occur in these end regions.

In the electric coil winding, both the electric conductor and the non-conductive element may comprise a strip material. The coil winding may comprise a flat coil with mutually superimposed layers of the strip material elements. In other words, the coil can comprise a fixed winding plane, within which all the turns are wound. The strip material conductor and the strip material non-conductive element can then be wound within this winding plane, such that the main surfaces of the strips are respectively arranged perpendicularly to the winding plane. The strip material elements of the successive turns can then lie flush, one on top of another.

In this connection, however, the above-mentioned strip material elements are not to be understood as flat strips only, but can also be present as strip material elements of different geometries: specifically, the non-conductive element may comprise a three-dimensionally structured strip. However, a flat strip geometry is also possible, both for the non-conductive element and for the electric conductor.

Regardless of their exact configuration, flat coils having a strip material electric conductor and a strip material non-conductive element generally have the advantage that these winding elements are arranged radially one on top of another, such that the elements in successive individual turns are mutually mechanically secured, and the entire coil winding is mechanically stable, even in the dry form. By the application of a tensile force to the non-conductive element, exceptionally good mechanical stability may then be achieved.

In some embodiments, the electric conductor comprises a superconducting material. Specifically, the conductor may comprise a superconducting strip conductor, in which a superconducting layer is applied to a normally conducting or non-conductive substrate. The superconducting material can be a high-temperature superconductor. High-temperature superconductors (HTS) are superconducting materials with a critical temperature in excess of K and, in certain material classes, for example cuprate superconductors, in excess of 77 K, wherein the service temperature can be achieved by cooling with cryogenic materials other than liquid helium. HTS materials are also particularly attractive, as these materials, depending upon the service temperature selected, can show both high upper critical magnetic fields and high critical current densities. In some embodiments, the high-temperature superconductor can comprise, for example, magnesium diboride or a ceramic oxide superconductor, for example a compound of the REBa₂Cu₃Oₓ type (REBCO for short), where RE stands for a rare earth element, or a mixture of such elements.

In coil windings with superconducting conductors, the mechanical stability of dry-wound coils is of particular importance as, in many cases, any embedding or adhesive bonding of the coil is not desirable, for example in the interests of achieving an open structure in which the superconducting conductor can maintain close contact with a liquid coolant. Cooling of the superconductor to a temperature below its critical temperature can thus be achieved more easily.

In some embodiments, the first end region may be arranged in an outer radial position. In an outer radial region of this type, specifically of a flat coil, it is particularly important to prevent any lateral shifting of the winding elements associated with electrostatic forces or variations in length, as the outermost turns are not mechanically supported by any further turns, and are thus particularly susceptible to lateral displacement. In some embodiments, however, the first end region can, in principle, also be arranged in an inner radial position. In some embodiments, both an inner radial end region and an outer radial end region of a coil winding can be configured in the manner described. In other words, the non-conductive element, both internally and externally, can be secured to a retaining element by means of an elastic tensile element. In some embodiments, on both sides, this attachment can be mechanically dissociated from any attachment of the electric conductor. In the inner and outer radial position respectively, a separate retaining element can be provided, to which the non-conductive element is mechanically secured in both end regions thereof. However, both end regions of the conductor, and thus both retaining elements, can also be arranged in the outer radial position, as is frequently the case, for example, in current limiter coils.

In some embodiments, the retaining element may comprise an electric contact element, to which the electric conductor is connected in an electrically conductive manner. In other words, the electric conductor can be connected to the same retaining element as the non-conductive element. The conductor can be rigidly mechanically connected to this retaining element and is thus mechanically dissociated from the elastically-secured non-conductive element. In some embodiments, the first retaining element can be an outer radial electric contact element. Additionally, some embodiments include a second retaining element, comprising an inner radial or an outer radial contact element, and to which the non-conductive element, in its second end region, is likewise secured by means of an elastic tensile element. The at least one contact element can be, for example, a copper contact piece.

In some embodiments, the non-conductive element comprises a spacer between individual and mutually superimposed turns of the electric conductor. Specifically, the clearance thus achieved between the superimposed turns can be greater than the thickness of the electric conductor. The spacer can specifically be a radial spacer between radially superimposed turns of a flat coil. In some embodiments, there is a radial clearance of at least 1 mm between the individual turns.

In some embodiments, the non-conductive element includes one or more cavities through which a coolant fluid can flow. When used with a superconducting conductor, cooling to a temperature below the critical temperature can then be achieved by means of the coolant. In some embodiments having superconducting coil windings, the individual turns are spaced by means of an intervening spacer, in order to permit a flow of coolant through the gaps thus constituted.

In some embodiments, the non-conductive element can comprise a corrugated strip. In the present context, a corrugated strip is a strip material element having a corrugated profile. This can involve either regular or irregular corrugations. These may comprise sinusoidal corrugations, or only approximately corrugated arrangements of polylines. In general, the corrugated strip comprises a series, in the longitudinal direction, of sequentially arranged corrugation peaks and corrugation troughs. By means of a structure of this type, the non-conductive element functions as a spacer between the adjacent turns of the electric conductor.

In some embodiments, the non-conductive element comprises a corrugated strip and one or more further components. For example, the non-conductive element may comprise a combination of at least one such corrugated strip with one or more flat strips. The individual components can either be loosely arranged, one on top of another, or can be permanently mechanically secured, for example by the adhesive bonding or welding of the individual components. In some embodiments, the non-conductive element can comprise a plastic. Plastics are generally well-suited to the purposes of electrical insulation and, at the same time, are sufficiently deformable to permit the winding thereof in a coil winding in the form of thin strips. For the purposes of electrical insulation between the adjacent turns of the electric conductor, for example, flat strips of plastics including, for example, polyester, polyethylene terephthalate (PET), polyimide (PI) of polytetrafluoroethylene (PTFE), specifically Hostaphan, Kapton or Teflon, can be employed. Plastics are also particularly suitable for a non-conductive element which is to function as a spacer. For employment in conjunction with superconducting electric conductors, the plastic may be designed for use in a cryogenic temperature range below the critical temperature of the superconductor. Specifically, the plastic can be suitable for immersion in the coolant fluid which is employed for cooling, including, for example, liquid nitrogen, liquid hydrogen, liquid helium or liquid neon, without losing its mechanical integrity.

In some embodiments, the non-conductive element has a greater width than the electric conductor. The width of these elements is generally to be understood as the extension thereof in a spatial direction which is perpendicular to their longitudinal extension, specifically their maximum extension perpendicularly to said longitudinal extension. Particularly in the case of strip material winding elements, the non-conductive element may be wider than the electric conductor so the electric conductor can then be embedded between the surrounding turns of the non-conductive element such that, in an axial direction of the coil winding, it is protected against external mechanical influences. In such embodiments, the path for any potential electric arcing between one turn of the conductor and the next is significantly extended. In this manner, the risk of unwanted electric arcing between the turns of the coil winding may be reduced.

In some embodiments, the non-conductive element having a relatively broad width can, in an interior region relative to the width thereof, incorporate a recess, or a series of recesses, in which the electric conductor is carried. In such an embodiment, the conductor—specifically in a flat coil geometry—is then not only radially embedded between the adjacent turns of the non-conductive element, but is also secured in the axial direction of the coil winding between sections of the non-conductive element. By an arrangement of this type, the mechanical stability of the entire winding may be improved, as the electric conductor is secured in position by the non-conductive element, and any lateral shift in the axial direction may be prevented, provided that the non-conductive element remains under tension. A tensile force of this type is however ensured by means of the mechanical attachment incorporating teachings of the present disclosure.

In general, the non-conductive element may comprise a plurality of parts. In some embodiments, at least one corrugated non-conductive strip may be combined with one or more flat non-conductive strips. In some embodiments, in which the non-conductive element is at least partially constituted of a plastic, plastic-based subelements can be mutually bonded in a sectional arrangement by thermal welding, in order to constitute an overall three-dimensional structure. A spacer for the turns of the electric conductor can thus be constructed in a particularly simple manner. In some embodiments, the elastic tensile element may exert a tensile force of at least 5 N on the non-conductive element. This tensile force can specifically act on the non-conductive element along a longitudinal direction thereof. By the configuration of a tensile force in this manner, a reliable re-tensioning of the non-conductive element can be achieved, by means of which effective retention is delivered and any axial shifting of the individual turns can thus be prevented. Where the tensile element comprises a tension spring, this can show, for example, a spring constant of at least 5 N/mm.

In some embodiments, the electric conductor can comprise at least two conductor branches, wherein at least two adjacent conductor branches in the winding are configured for mutually opposing directions of current flow. In some embodiments, the coil winding serves in a current limiter on the grounds that, by the alternation of the directions of current flow in this manner, the inductances of the two winding elements are mutually compensated. In the normal operating state of the current limiter, the alternating current losses can be kept low accordingly.

In an arrangement having only two conductor branches, the coil winding can specifically be configured in the form of a “bifilar coil winding”. In arrangements having more than two conductor branches, directions of current flow can either be varied between each adjacent pair of conductor branches, or else adjacent conductor branches can be present which are energized both in the same direction and in different directions. In some embodiments, at least one pair of adjacent conductor branches is present in the winding, in which the directions of current flow to be applied in service are in mutual opposition. In a coil winding of this type, the application of a tensile force to the at least one non-conductive element according to the invention is particularly relevant, as the adjacent conductor branches will undergo mutual repulsion in service, such that it is easy for the loosening of the composite structure of the winding to occur. This electrically-related loosening of the composite structure of the winding is advantageously prevented by the solution according to the invention, as the non-conductive element is permanently tensioned. The tensile force applied, as indicated above, can be configured with sufficient strength, such that the mechanical integrity of the winding is sufficiently high to prevent any lateral displacement of the turns, even during electrical operation.

In some embodiments, the coil winding may be employed in a fault current limiter. Specifically, this can comprise a superconducting fault current limiting device. The current limiter may comprise a resistive, inductive, or inductive-resistive current limiter. The current limiter can comprise one or more coil windings according to the invention. In the event of a plurality of coil windings, these can specifically be stacked in an axial direction.

In some embodiments, however, the coil winding may be employed in a rotating machine, e.g. for example in the rotor or stator windings of a rotor or generator. In some embodiments, the coil winding may be used as a magnetic coil for the generation of magnetic fields, specifically as a superconducting magnetic coil for magnetic resonance imaging or magnetic resonance spectroscopy.

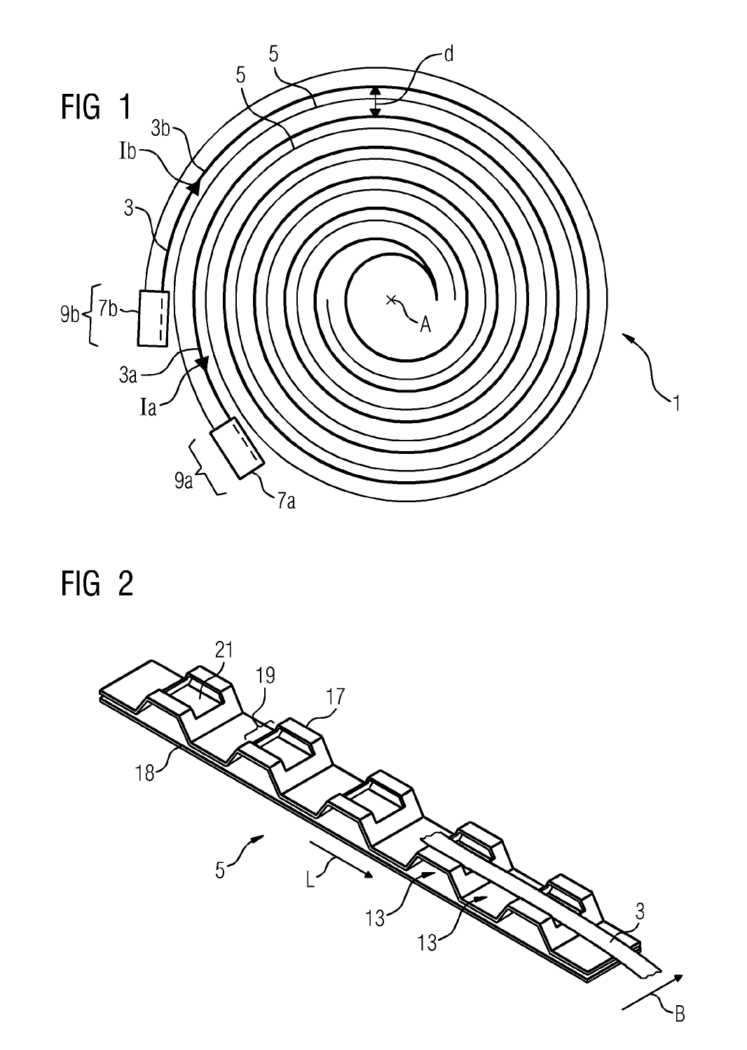

FIG. 1 shows a schematic view of a coil winding 1 of a fault current limiter incorporating teachings of the present disclosure. A flat coil is represented, in which an electric conductor 3 is wound in a plurality of turns, within a fixed winding plane, about a central winding axis A. In this case, the electric conductor comprises two conductor branches 3a and 3b which, in the example represented, are interconnected in the center of the winding and are arranged in the form of a “bifilar winding”, such that the directions of current flow Ia and Ib in the conductor branches 3a and 3b arranged adjacently in the winding are in mutual opposition. Between the adjacent turns of the two conductor branches 3a and 3b, a non-conductive element 5 is respectively arranged. The total of two non-conductive elements 5 provided in this case thus separate the adjacent turns of the electric conductor 3 over the entire length of the winding. Accordingly, the adjacent turns, as a result of the insulating properties of the elements 5 are firstly electrically isolated and, as a result of the thickness of the elements 5, are secondly maintained at a specific clearance d. The elements 5 are only schematically represented as flat lines. In the present example, however, they also incorporate a significant extension in the radial direction, and assume an overall three-dimensional structure, as described in greater detail hereinafter.

In this case, as a result of the folding of the conductor in the center of the coil winding, as represented, the two ends of the electric conductor 3 are both arranged in outer radial regions of the winding. In the first end region 9a, the first conductor branch 3a is connected to a first retaining element 7a, which simultaneously functions as a contact element for said conductor branch 3a. It can be configured, for example, as a solid copper block. Analogously, in the second end region 9b, the second conductor branch 3b is connected to a corresponding second retaining element 7b, which likewise functions as a contact element. In the end regions 9a and 9b, the two conductor branches 3a and 3b which are contacted at this location are respectively covered on the outer radial side, approximately to the extent of the respective retaining element, by one of the non-conductive elements 5, and are thus mechanically protected to the exterior. The non-conductive elements 5 are mechanically connected to the respective retaining elements 7a and 7b. The embodiment of the coil winding 1 according to the invention, which is described in greater detail hereinafter with reference to FIG. 4, differs from the prior art with respect to the exact nature of the mechanical attachment of the non-conductive elements 5 to the retaining elements 7a and 7b.

FIG. 2 shows a detailed view of the non-conductive element 5 represented in FIG. 1. A section of the non-conductive element 5 of the coil winding 1 configured as a spacer is represented, with an electric conductor 3 arranged therein, in a schematic oblique view. Here, the width of the spacer is represented by B, and the direction of its longitudinal extension is represented by L.

In this case, the electric conductor 3 comprises a superconducting strip conductor, for example as a strip conductor having a high-temperature superconducting layer arranged on a normally conducting substrate. Strip conductors of this type which are particularly suitable for superconducting current limiters are described in greater detail in DE 10 2004 048 646 A1. The non-conductive element 5 is thus configured to function as a spacer between adjacent turns of the conductor 3. To this end, the non-conductive element 5, in the example represented, comprises two parts, namely, a flat strip 18 and a corrugated strip 17. The two strips, in the closely mutually adjacent regions—e.g. in the regions of the corrugation troughs represented in FIG. 2—can be mechanically interconnected, for example by means of welding or adhesive bonding. In the region of the corrugation peaks, the corrugated strip 17 incorporates recesses 21 into which, in the finished coil winding 1, the strip material conductor 3 can be inserted, as represented in an exemplary manner in the right-hand section of FIG. 2.

By means of a non-conductive spacer of this type, as represented in an exemplary manner in FIG. 2, it can be achieved that, firstly, a specific clearance is maintained between the turns of the superconducting conductor 3, and secondly, by means of the open structure, cavities 13 are constituted between the turns, through which a coolant fluid can flow. In the context of the present invention, however, the configuration of the non-conductive element according to FIG. 2 is to be understood as exemplary only. Further forms of embodiment of the spacer can be configured as described in EP 2041808 B1.

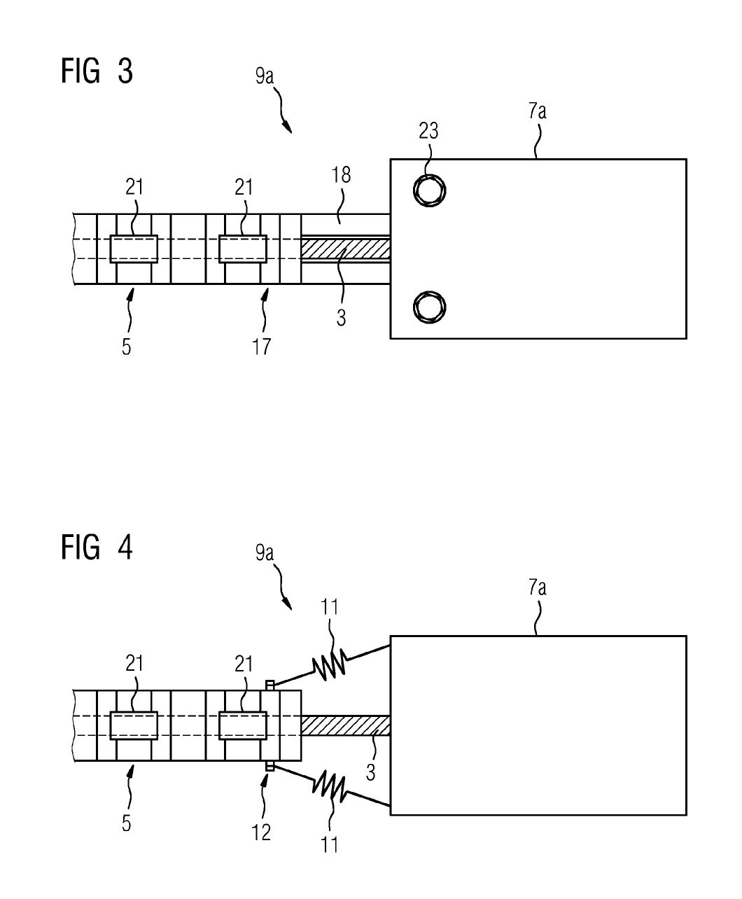

According to the prior art, coil windings of this type, as described with reference to FIG. 1 and FIG. 2 are secured by means of a rigid connection of the electric conductor 3 and the non-conductive element 5 to the respective retaining elements 7a and 7b. FIG. 3 shows a conventional configuration of the mechanical connection of this type, in the end region 9a, according to the prior art. FIG. 3 shows a lateral view of the end region 9a, from an outer radial position in relation to the retaining element 7a shown in FIG. 1. The outer radial non-conductive element 5 is represented which, in the left-hand section of the drawing, covers the underlying conductor 3.

Here, this conductor 3 is represented by a broken line only. In this case, the recesses 21 of the non-conductive element 5 represented are not occupied by a conductor, as the conductor represented here is secured on the non-conductive element 5 in the corrugated strip of the underlying layer. In the central section of the drawing, the conductor 3 can be seen in full, as the corrugated strip 17 of the outer non-conductive element 5 does not extend entirely to the retaining element 7a and, in consequence, the conductor 3 is no longer covered at this point.

Likewise, in the central section of the drawing, the flat strip which is arranged below the corrugated strip 17, in its central region, incorporates a recess, through which the electric conductor 3 is routed radially outwards. Accordingly, only the two outermost sections of the flat strip 18 are routed as far as the retaining element 7a. In the configuration of the retaining arrangement according to the prior art represented, both the conductor 3 and the outermost sections of the flat strip 18 are secured to the retaining element 7a in a rigid connection, by means of screws 23. To this end, both the electric conductor 3 and the sections of the flat strip 18 are inserted between two sections of the retaining element 7a which are screwed together. This type of fixing has the disadvantages described in the introductory section, in that a variation in the length of the non-conductive element and/or any loosening of the winding associated with the operation of the coil cannot be compensated. In principle, it is possible to execute a manual re-tensioning further to initial entry into service, or further to the first functional test. However, this is highly complex, and requires the removal of the coil winding from the finished current limiter device. Moreover, a subsequent intervention of this type entails a risk of damage to the superconductor.

Finally, in a distinction from FIG. 3, FIG. 4 shows a configuration incorporating teachings of the present disclosure for the attachment of the winding elements to the retaining element 7a. Here again, a lateral view of the end region 9a is represented, from an outer radial position. In this case, however, in a distinction from the attachment shown in FIG. 3, the non-conductive element 5 is not routed quite as far as the retaining element 7a. It is not directly and rigidly connected to the latter, but is secured to the latter via elastic tensile elements. In the example represented, two such elastic tensile elements 11 are present in the form of tension springs which, by means of a retaining pin 12 inserted into one of the cavities 13 between the corrugated strip 17 and the flat strip 18, are connected to the latter. However, other means of attachment to the non-conductive element 5 are also conceivable.

It is also sufficient that the non-conductive element 5 and the retaining element 7a are mutually connected by a single elastic tensile element only. It is essential that, by means of the elastic tensile element 11, a tensile force is exerted on the non-conductive element 5, which effects the in-service re-tensioning of the non-conductive element 5 and can thus offset any forces that weaken the composite structure of the winding. The non-conductive element 5 is thus secured to the retaining element 7a in a manner which is dissociated from the electric conductor 3. By the continuous application of a tensile force to the non-conductive element 5, a mechanical integrity of the coil winding can be achieved, even in the absence of any adhesive bonding or embedding of the winding.

The mechanical fixing of the non-conductive element as taught herein is not restricted to the configuration of the non-conductive element represented in FIG. 2. The advantages coming therefrom are likewise not restricted to current limiter coils having a geometry according to FIG. 1. The configurations according to FIG. 1 and FIG. 2 are to be considered for exemplary purposes only, in the interests of the clarification of the action of the invention. In general, the advantages of the attachment will also apply if, for example:
the coil winding does not assume the form of a flat coil, but is configured, for example, in the form of a solenoid coil or saddle coil,
the coil winding is not bifilar, but is configured, for example, as a winding with continuous flow of current in the same direction in adjacent turns,
the coil winding is not designed for current limiting, but for employment, for example, as a magnetic coil or a coil in an electrical machine,
the end regions of the conductor do not both assume an outer radial arrangement but, for example, one assumes an outer radial arrangement and the other an inner radial arrangement,
the at least one retaining element is not simultaneously configured as a contact element for the conductor,
the electrical conductor and/or the non-conductive element are not constituted of strip materials
and/or if the electric conductor is not superconducting.

What is claimed is:

1. An electric coil winding comprising:
an electric conductor;
a non-conductive element wound in parallel to the electric conductor throughout a number of turns forming a coil; and
a first retaining element arranged in a first end region of the coil; and
wherein the non-conductive element is mechanically secured to the retaining element by means an elastic tensile element.

2. The electric coil winding as claimed in claim 1, wherein:
the electric conductor comprises a strip;
the non-conductive element comprises a strip; and
the coil comprises a flat coil with mutually superimposed layers of the electric conductor strip and the non-conductive element strip.

3. The electric coil winding as claimed in claim 1, wherein the electric conductor comprises a superconducting conductor material.

4. The electric coil winding as claimed in claim 1, wherein the first end region is arranged in an outer radial position.

5. The electric coil winding as claimed in claim 1, wherein:
the retaining element comprises an electric contact element; and
the electric conductor is connected in an electrically conductive manner to the electric contact element.

6. The electric coil winding as claimed in claim 1, wherein the non-conductive element comprises a spacer disposed between individual and mutually superimposed turns of the electric conductor.

7. The electric coil winding as claimed in claim 6, wherein the non-conductive element includes one or more cavities through which a coolant fluid can flow.

8. The electric coil winding as claimed in claim 6, wherein the non-conductive element comprises a corrugated strip.

9. The electric coil winding as claimed in claim 1, wherein the non-conductive element comprises a plastic material.

10. The electric coil winding as claimed in claim 1, wherein the non-conductive element has a width greater than a width of the electric conductor.

11. The electric coil winding as claimed in claim 10, wherein the electric conductor is disposed at least partially within a recess of the non-conductive element.

12. The electric coil winding as claimed in claim 1, wherein the non-conductive element comprises a plurality of parts.

13. The electric coil winding as claimed in claim 1, wherein the elastic tensile element exerts a tensile force of at least 5 N on the non-conductive element.

14. The electric coil winding as claimed in claim 1, wherein:
the electric conductor comprises at least two conductor branches; and
at least two adjacent conductor branches in the winding are configured for mutually opposing directions of current flow.

15. (canceled)
